(19) United States
(12) Patent Application Publication
(10) Pub. No.: US 2026/0293813 A1
(43) Pub. Date: Oct. 1, 2026

(54) CLUTCH ASSEMBLY WITH TWO OUTPUTS FOR AN AGRICULTURAL HARVESTER ROW UNIT

(71) Applicant: CNH Industrial America LLC, New Holland, PA (US)

(72) Inventor: Nicholas Laufenberg, Glen Ellyn, IL (US)

(21) Appl. No.: 19/091,127

(22) Filed: Mar. 26, 2025

(51) Int. Cl. A01D 69/08; A01D 46/16; A01D 69/06

(52) U.S. Cl. CPC A01D 69/08; A01D 46/16; A01D 69/06

(57) ABSTRACT

A gear drive assembly includes a dual-output clutch assembly. The dual-output clutch assembly includes a shaft; a first gear configured to drive the first rotor assembly to rotate, a second gear configured to drive the second rotor assembly to rotate, a first radial pin clutch including a first plurality of radial pins moveably coupled to the shaft, and a second radial pin including a second plurality of radial pins moveably coupled to the shaft. The pluralities of radial pins are configured to block rotation of the gears about the shaft in an engaged state, and the pluralities of radial pins are configured to enable rotation of the gears about the shaft in a disengaged state in response to a torque between the gears and the shaft exceeding a threshold torque. The first radial pin clutch is configured to operate independently of the second radial pin clutch.

### BACKGROUND

The present disclosure relates generally to a clutch assembly with two outputs for an agricultural harvester row unit.

Agricultural harvesters are used to harvest agricultural products (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

Certain row units include two rotors, and each rotor includes multiple spindles (e.g., barbed spindles) configured to engage a crop (e.g., a cotton plant). The rotors may be positioned on opposite sides of a central path or on the same side of the central path, and the spindles extend into the central path. During operation of the agricultural harvester, the row unit is positioned to align a row of crops with the central path. Accordingly, as the agricultural harvester traverses the field, the spindles of the rotors engage each plant of the row. The rotors are driven to rotate, such that engagement of the spindles with the crop separates the agricultural product (e.g., seed cotton) from the plant stalk. The agricultural product collects on the spindles and is removed from the spindles by doffers, which are positioned adjacent to the rotors. The air-assisted conveying system moves the agricultural product from the row unit to the accumulator. After the agricultural product is removed from the spindles of each rotor, the spindles pass through a respective moistener column assembly to remove buildup of crop liquids (e.g., sap, etc.) from the spindles. The rotors may be driven to rotate together via a common drive shaft.

### SUMMARY

In certain embodiments, a gear drive assembly includes a dual-output clutch assembly. The dual-output clutch assembly includes a shaft; a first gear configured to drive the first rotor assembly to rotate, a second gear configured to drive the second rotor assembly to rotate, a first radial pin clutch including a first plurality of pins moveably coupled to the shaft, and a second radial pin including a second plurality of pins moveably coupled to the shaft. The first gear has a first plurality of recesses configured to receive the first plurality of radial pins, and the second gear has a second plurality of recesses configured to receive the second plurality of radial pins. The first plurality of radial pins is configured to move in a radial direction between a first engaged state and a first disengaged state, and the second plurality of radial pins is configured to move in the radial direction between a second engaged position and a second disengaged state. The first plurality of radial pins is configured to engage the first plurality of recesses while in the first engaged state to block rotation of the first gear about the shaft, and the first plurality of recesses is configured to drive the first plurality of radial pins to the first disengaged state to enable rotation of the first gear about the shaft in response to a first torque between the first gear and the shaft exceeding a first threshold torque. The second plurality of radial pins is configured to engage the second plurality of recesses while in the second engaged state to block rotation of the second gear about the shaft, and the second plurality of recesses is configured to drive the second plurality of radial pins to the second disengaged state to enable rotation of the second gear about the shaft in response to a second torque between the second gear and the shaft exceeding a second threshold torque. The first radial pin clutch is configured to operate independently of the second radial pin clutch.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header;

FIG. 2 is a schematic top view of an embodiment of a row unit that may be employed within the header of FIG. 1;

FIG. 3 is a perspective view of a portion of an embodiment of the row unit of FIG. 2, in which the row unit includes a gear drive assembly;

FIG. 4 is a side view of an embodiment of a dual-output clutch assembly that may be employed within the gear drive assembly of FIG. 3;

FIG. 5 is a side cross-sectional view of the dual-output clutch assembly of FIG. 4;

FIG. 6 is a top cross-sectional view of the dual-output clutch assembly of FIG. 4, taken along line 6-6 of FIG. 4; and

FIG. 7 is another top cross-sectional view of the dual-output clutch assembly of FIG. 4, taken along line 7-7 of FIG. 4.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

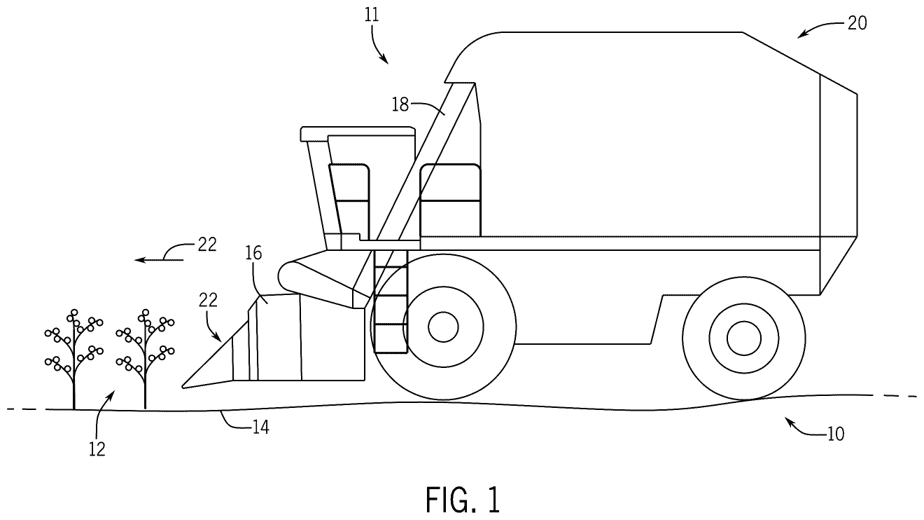

FIG. 1 is a side view of an embodiment of an agricultural harvester 10 having a header 16. The agricultural harvester 10 harvests agricultural product 12 (e.g., seed cotton) from a field 14 and forms the agricultural product 12 into bales (e.g., agricultural bales). In the illustrated embodiment, the header 16 of the agricultural harvester 10 includes multiple row units 22 distributed across the width of the header 16. Each row unit 22 is configured to harvest a respective row of the agricultural product 12 from the field 14. Additionally, the agricultural harvester 10 includes an agricultural product transport assembly 11 having an air-assisted conveying system 18 configured to move the agricultural product 12 from the row units of the header 16 to an accumulator of the agricultural product transport assembly 11. The agricultural product transport assembly 11 also includes a conveying system configured to convey the agricultural product 12 from the accumulator into a baler 20. The baler 20 is supported by and/or mounted within or on a chassis of the agricultural harvester 10. The baler 20 may form the agricultural product 12 into round bales. However, in other embodiments, the baler 20 of the agricultural harvester 10 may form the agricultural product into square bales, polygonal bales, or bales of other suitable shape(s). After forming the agricultural product 12 into a bale, a bale wrapping system of the agricultural harvester 10 wraps the bale with a bale wrap to secure the agricultural product 12 within the bale and to generally maintain a shape of the bale.

As discussed in detail below, each row unit 22 includes two rotor assemblies positioned on opposite sides of a central path through the row unit 22 or on the same side of the central path. Each rotor assembly includes multiple spindles (e.g., barbed spindles) extending into the central path and a drum assembly, in which the spindles are mounted on the drum assembly. The spindles are configured to engage a crop (e.g., cotton plant) along a substantial portion of the height of the crop. During operation of the agricultural harvester 10, the central path of the row unit 22 is aligned with a row of crops. Accordingly, as the agricultural harvester 10 traverses the field 14, the row unit 22 receives each crop of the row, and the spindles of the rotor assemblies engage the crop. The rotor assemblies are driven to rotate, such that engagement of the spindles with the crop separates the agricultural product 12 (e.g., seed cotton) from the plant stalk (e.g., the crop after the agricultural product is removed). The agricultural product 12 removed from the crop collects on the spindles, and the agricultural product is removed from the spindles by doffers. Each doffer directs the agricultural product 12 to a respective conveying chamber, and the air-assisted conveying system 18 moves the agricultural product 12 from the conveying chambers to the accumulator. After the agricultural product 12 is removed from the spindles of each rotor assembly, the spindles pass through a respective moistener column assembly to remove buildup of crop liquids (e.g., sap, etc.) from the spindles. As the rotor assemblies continue to rotate, the spindles engage a subsequent crop at the central path.

The row unit may include a first rotor assembly, a first doffer, a second rotor assembly, a second doffer, and a gear drive assembly. The gear drive assembly may include a dual-output clutch assembly. The dual-output clutch assembly may include a shaft, a first gear configured to drive the first rotor assembly and the first doffer to rotate, a second gear configured to drive the second rotor assembly and the second doffer to rotate, a first radial pin clutch including a first set of pins moveably coupled to the shaft, and a second radial pin clutch including a second set of pins moveably coupled to the shaft. The dual-output clutch assembly enables a single shaft to drive rotation of the first gear and the second gear, thereby reducing the size and complexity of the gear drive assembly. In addition, in response to termination of rotation of one rotor assembly and doffer (e.g., due to accumulation of agricultural product within the rotor assembly), the shaft may continue to drive the other rotor assembly and doffer in rotation.

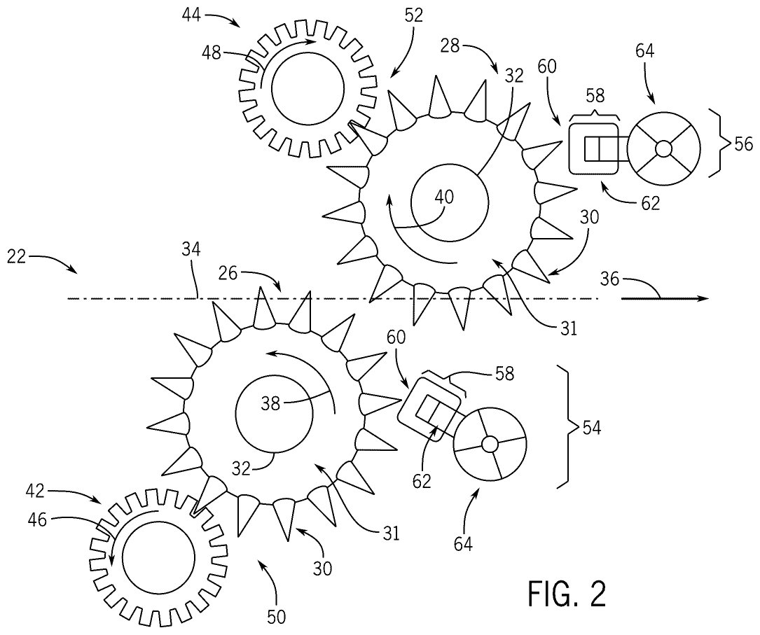

FIG. 2 is a schematic top view of an embodiment of a row unit 22 that may be employed within the header of FIG. 1. In the illustrated embodiment, the row unit 22 includes a first rotor assembly 26 and a second rotor assembly 28. As illustrated, each rotor assembly includes multiple spindles 30 (e.g., barbed spindles) configured to engage a crop (e.g., cotton plant) and a drum assembly 31, in which the spindles 30 are mounted on the drum assembly 31. For example, each spindle 30 may include three rows of barbs. Each drum assembly is configured to rotate about a respective central shaft 32 (e.g., rotor shaft). In addition, each drum assembly includes two end structures rotatably coupled to the central shaft and multiple spindle bars rotatably coupled to the end structures. The spindle bars extend along a vertical axis of the row unit 22, the spindle bars are circumferentially distributed (e.g., evenly circumferentially distributed) about the end structures, and each spindle bar is configured to support multiple spindles. The spindles 30 extend radially outward from each spindle bar, the spindles 30 coupled to each spindle bar are distributed along the vertical axis of the row unit 22, and the spindles 30 coupled to each spindle bar point in the same direction. Because the spindles 30 are distributed along the vertical axis, the spindles 30 engage the crop along a substantial portion of the height of the crop. Furthermore, an orientation control arm is coupled to each spindle bar, a roller is coupled to an end of each orientation control arm, and the rollers engage a cam track. The cam track is configured to control the orientation of each spindle bar relative to the end structures as the drum assembly rotates, thereby controlling an orientation of the spindles with respect to the crop, with respect to a doffer, and with respect to a moistener column assembly. In addition, each spindle 30 is driven to rotate relative to the respective spindle bar. For example, a spindle drive gear may be coupled to each spindle bar, a spindle gear may be coupled to each spindle, the spindle drive gear may be driven to rotate by rotation of the rotor assembly, and the spindle drive gear may drive the spindle gears to rotate, thereby rotating each spindle. As each spindle engages the agricultural product, rotation of the spindle drives the barbs to capture the agricultural product (e.g., seed cotton), such that the agricultural product wraps around the spindle.

In the illustrated embodiment, the first rotor assembly 26 and the second rotor assembly 28 are positioned on opposite sides of a central path 34 through the row unit 22, and the spindles 30 of each rotor assembly extend into the central path 34. During operation of the agricultural harvester, the central path 34 of the row unit 22 is aligned with a row of crops. Accordingly, as the agricultural harvester traverses the field along a direction of travel 36, the row unit 22 receives each crop of the row, and the spindles 30 of each rotor assembly engage the crop. The first rotor assembly 26 is driven to rotate in a first rotor rotational direction 38, and the second rotor assembly 28 is driven to rotate in a second rotor rotational direction 40, opposite the first rotor rotational direction 38. The rotational speed of each rotor assembly may be selected such that the tangential speed of the spindles 30 due to rotation of the rotor assembly is equal to the ground speed of the row unit 22 along the direction of travel 36, thereby enabling the spindles 30 to engage the crop at a substantially zero relative speed. Engagement of the spindles 30 with the crop separates the agricultural product (e.g., seed cotton) from the plant stalk (e.g., the crop after the agricultural product is removed). While the first and second rotor assemblies are positioned on opposite sides of the central path in the illustrated embodiment, in other embodiments, the first and second rotors may be positioned on the same side of the central path.

The agricultural product removed from the crop collects on the spindles 30 of the rotor assemblies. In the illustrated embodiment, the row unit 22 includes a first doffer 42 configured to remove the agricultural product from the spindles 30 of the first rotor assembly 26, and the row unit 22 includes a second doffer 44 configured to remove the agricultural product from the spindles 30 of the second rotor assembly 28. Each doffer includes a stack of discs configured to engage the spindles 30 of the respective rotor assembly to remove the agricultural product from the spindles 30. The number of discs of each doffer may be equal to the number of spindles on each spindle bar. As illustrated, the first doffer 42 is configured to rotate in a first doffer rotational direction 46, which is the same as the first rotor rotational direction 38, and the second doffer 44 is configured to rotate in a second doffer rotational direction 48, which is the same as the second rotor rotational direction 40. Each doffer rotates at a rotational speed that establishes a doffer tangential speed greater than a tangential speed of the spindles due to rotation of the spindles relative to the respective spindle bars. Accordingly, the interaction between the discs of the doffer and the spindles 30 of the respective rotor assembly unwinds the agricultural product (e.g., seed cotton) from the spindles 30, thereby removing the agricultural product and directing the agricultural product to a respective conveying chamber. As illustrated, a first conveying chamber 50 is positioned adjacent to the first doffer 42 and the first rotor assembly 26, and a second conveying chamber 52 is positioned adjacent to the second doffer 44 and the second rotor assembly 28. The air-assisted conveying system moves the agricultural product from each conveying chamber to the accumulator.

After the agricultural product is removed from the spindles 30 of the first rotor assembly 26, the spindles 30 pass through a first moistener column assembly 54, and after the agricultural product is removed from the spindles 30 of the second rotor assembly 28, the spindles 30 pass through a second moistener column assembly 56. Each moistener column assembly is configured to remove crop liquids (e.g., sap, etc.) from the spindles 30. In the illustrated embodiment, each moistener column assembly includes multiple moistener pad assemblies 58 distributed along the vertical axis of the row unit 22. The number of moistener pad assemblies 58 may be equal to the number of spindles 30 on each spindle bar. Each moistener pad assembly 58 includes a moistener pad 60 and a moistener pad holder 62 configured to support the moistener pad 60. Each moistener column assembly also includes a moistener column 64 configured to direct cleaning fluid to each moistener pad assembly 58. The moistener pads 60 are positioned to engage respective spindles 30 as the respective rotor assembly rotates, thereby applying the cleaning fluid to the spindles 30 and wiping the crop liquids off the spindles 30. As the rotor assemblies continue to rotate, the spindles 30 engage a subsequent crop at the central path 34.

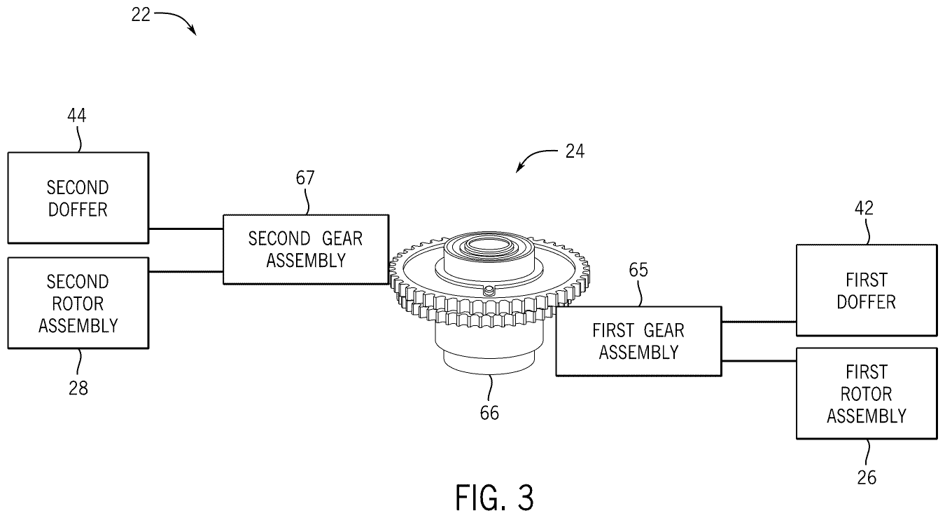

FIG. 3 is a perspective view of a portion of an embodiment of the row unit 22 of FIG. 2, in which the row unit 22 includes a gear drive assembly 24. In the illustrated embodiment, the gear drive assembly 24 includes a dual-output clutch assembly 66 configured to drive the first rotor assembly 26, the second rotor assembly 28, the first doffer 42, and the second doffer 44 to rotate. As discussed in detail below, the dual-output clutch assembly 66 is configured to drive the first rotor assembly 26 and the first doffer 42 to rotate independently of the second rotor assembly 28 and the second doffer 44. As illustrated, the dual-output clutch assembly 66 is configured to drive the first rotor assembly 26 and the first doffer 42 to rotate via a first gear assembly 65, and the dual-output clutch assembly 66 is configured to drive the second rotor assembly 28 and the second doffer 44 to rotate via a second gear assembly 67. As discussed in detail below, the dual-output clutch assembly 66 includes a first gear 70 configured to engage the first gear assembly 65 to drive the first rotor assembly 26 and the first doffer 42 to rotate, and the dual-output clutch assembly 66 includes a second gear 72 configured to engage the second gear assembly 67 to drive the second rotor assembly 28 and the second doffer 44 to rotate.

The first radial pin clutch includes a first set of pins moveably coupled to the shaft, and the second radial pin clutch includes a second set of pins moveably coupled to the shaft. The first gear has a first set of recesses configured to receive the first set of pins, and the second gear has a second set of recesses configured to receive the second set of pins. The first set of pins is configured to move in a radial direction between a first engaged state and a first disengaged state, and the second set of pins is configured to move in the radial direction between a second engaged state and a second disengaged state. In the first engaged state, the first set of pins is configured to engage the first set of recesses to block the rotation of the first gear about the shaft. Similarly, in the second engaged state, the second set of pins is configured to engage the second set of recesses to block the rotation of the second gear about the shaft. The first set of recesses is configured to drive the first set of pins to a first disengaged state to enable rotation of the first gear about the shaft in response to a first torque between the first gear and the shaft exceeding a first threshold torque. Similarly, the second set of recesses is configured to drive the second set of pins to a second disengaged state to enable rotation of the second gear about the shaft in response to a second torque between the first gear and the shaft exceeding a second threshold torque. The first pin clutch is configured to operate independently of the second pin clutch. As such, the first gear may stop rotating independently of the second gear, and the second gear may stop rotating independently of the first gear. Therefore, the first rotor assembly and the first doffer may stop rotating independently of the second rotor assembly and the second doffer, and the second rotor assembly and second doffer may stop rotating independently of the first rotor assembly and the first doffer. This functionality enables the first rotor assembly and the first doffer to continue to rotate while the second rotor assembly and the second doffer is stopped in response to an accumulation of agricultural product and/or foreign materials within the second rotor assembly or the second doffer, and vice versa.

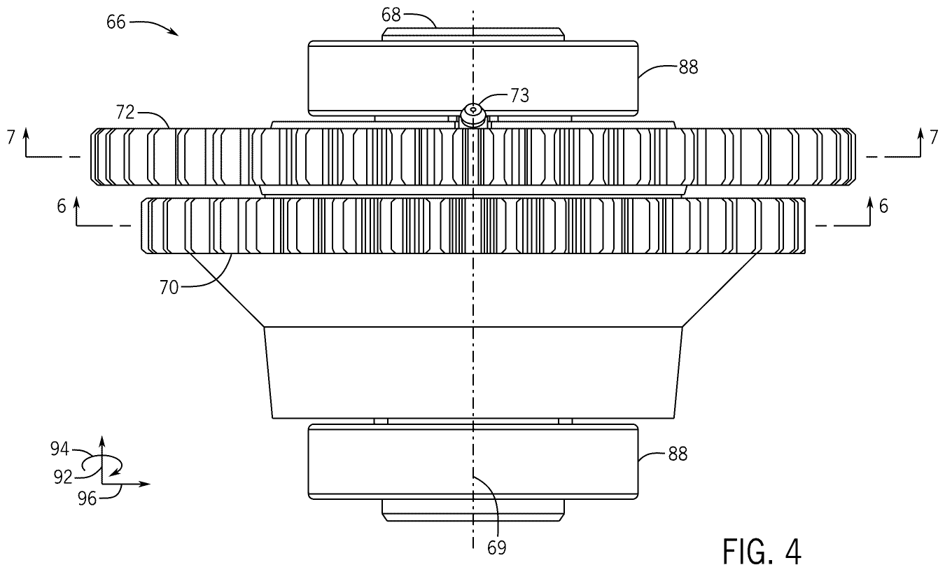

FIG. 4 is a side view of an embodiment of a dual-output clutch assembly 66 that may be employed within the gear drive assembly of FIG. 3. In the illustrated embodiment, the dual-output clutch assembly 66 includes a shaft 68, a first gear 70, and a second gear 72. The first gear 70 and the second gear 72 receive the shaft 68, such that the first gear 70 and the second gear 72 are disposed about the shaft 68. The first gear 70 and the second gear 72 are positioned proximate to one another along a vertical axis 69 of the dual-output clutch assembly 66. The first gear 70 is configured to engage the first gear assembly to drive the first rotor assembly and the first doffer to rotate. In addition, the second gear 72 is configured to engage the second gear assembly to drive the second rotor assembly and the second doffer to rotate. While the first and second radial pin clutches are engaged, rotation of the shaft drives the first and second gears to rotate, thereby driving the first rotor assembly, the first doffer, the second rotor assembly, and the second doffer to rotate. The shaft may be driven to rotate by any suitable motor(s), such as hydraulic motor(s), pneumatic motor(s), electric motor(s), other suitable type(s) of motor(s), or a combination thereof.

Due to the first and second radial pin clutches, the first gear 70 and the second gear 72 may rotate independently of one another. For example, while the first radial pin clutch is engaged (e.g., the first set of pins is in the first engaged state) and the second radial pin clutch is disengaged (e.g., the second set of pins is in the second disengaged state), the shaft 68 may drive the first gear 70 to rotate, thereby driving the first rotor assembly and the first doffer to rotate, while the second gear 72 does not rotate. In addition, while the first radial pin clutch is disengaged (e.g., the first set of pins is in the first disengaged state) and the second radial pin clutch is engaged (e.g., the second set of pins is in the second engaged state), the shaft 68 may drive the second gear 72 to rotate, thereby driving the second rotor assembly and the second doffer to rotate, while the first gear 70 does not rotate.

The dual-output clutch assembly includes bearings 88 disposed along an outer circumference of the shaft 68. In some embodiments, at least one bearing may be radially (e.g., with respect to the radial axis 96) disposed between the first gear 70 and the outer circumference of the shaft 68, at least one bearing may be radially disposed between the second gear 72 and the outer circumference of the shaft 68, at least one bearing may be radially disposed between a frame of the row unit and the outer circumference of the shaft 68, or any combination thereof. The bearings 88 are configured to facilitate the rotation of the shaft relative to the first gear 70, the second gear 72, the frame, or any combination thereof. The dual-output clutch assembly also includes an inlet 73 that enables lubricant to be provided to one or more sets of pins and/or a bushing.

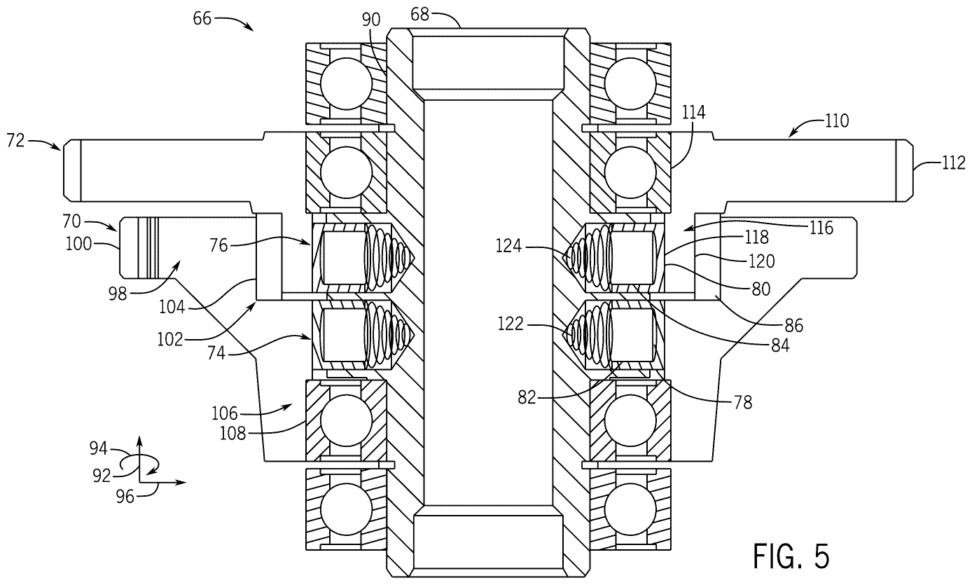

FIG. 5 is a side cross-sectional view of the dual-output clutch assembly 66 of FIG. 4. As illustrated, the dual-output clutch assembly 66 includes the shaft 68, the first gear 70, the second gear 72, the first radial pin clutch 74, and the second radial pin clutch 76. Bearings 88 are also disposed along an outer circumference 90 of the shaft 68. Each bearing 88 may include any suitable type of bearing, such as a ball bearing, a roller bearing, etc. The bearings 88 are distributed along the vertical axis 92, and each bearing extends about the shaft 68 along a circumferential axis 94 of the dual-output clutch assembly 66. At least one bearing 88 is radially disposed between the shaft 68 and the first gear 70 (e.g., with respect to a radial axis 96 of the dual-output clutch assembly 66). In addition, at least one bearing 88 is radially disposed between the shaft 68 and the second gear 72 (e.g., with respect to the radial axis 96). The bearings 88 radially disposed between the shaft 68 and the gears facilitate rotation of each gear about the shaft while the respective radial pin clutch is disengaged. Furthermore, two bearings 88 are configured to be radially disposed between the shaft 68 and a frame of the row unit, thereby facilitating rotation of the shaft relative to the frame. While one bearing is radially disposed between each gear and the shaft in the illustrated embodiment, in other embodiments, more or fewer bearings may be radially disposed between at least one gear and the shaft (e.g., 0, 2, 3, 4, or more). For example, in certain embodiments, the bearings radially disposed between the gears and the shaft may be omitted. In such embodiments, at least one bushing may be radially disposed between at least one gear and the shaft. Furthermore, while two bearings are configured to be radially disposed between the shaft and the frame in the illustrated embodiment, in other embodiments, more or fewer bearings may be configured to be radially disposed between the shaft and the frame (e.g., 0, 1, 3, 4, 5, 6, or more). For example, in certain embodiments, the bearings configured to be radially disposed between the shaft and the frame may be omitted. In such embodiments, at least one bushing may be configured to be radially disposed between the shaft and the frame.

The first radial pin clutch 74 includes a first set of pins 82 (e.g., radial pins) moveably coupled to the shaft 68. The first gear 70 has a first set of recesses 78 configured to receive the first set of pins 82. The first set of pins 82 is configured to move in a radial direction (e.g., along the radial axis 96) between a first engaged state and a first disengaged state. Similarly, the second radial pin clutch 76 includes a second set of pins 84 (e.g., radial pins) moveably coupled to the shaft 68. The second gear 72 has a second set of recesses 80 configured to receive the second set of pins 84. The second set of pins 84 is configured to move in the radial direction between a second engaged state and a second disengaged state.

In the illustrated embodiment, the first gear 70 has a first disc 98 with an outer edge 100. The outer edge 100 of the disc 98 includes gear teeth configured to engage corresponding gear teeth of the first gear assembly. In addition, the first gear 70 has an annular recess 102 formed within the disc 98. The annular recess 102 has an inner edge 104 (e.g., inner edge 104 of disc 98). Furthermore, the first gear 70 has an annular protrusion 106 (e.g., a first annular protrusion) extending perpendicularly from the disc 98 with respect to the vertical axis 92, and the annular protrusion 106 has an inner edge 108. The first set of recesses 78 is formed at the inner edge 108 of the annular protrusion 106. In addition, a respective bearing 88 is radially disposed between the inner edge 108 (e.g., the inner circumference) of the annular protrusion 106 and the shaft 68.

Furthermore, the second gear 72 has a disc 110 with an outer edge 112 and an inner edge 114. The outer edge 112 of the disc 110 includes gear teeth configured to engage corresponding gear teeth of the second gear assembly. The second gear 72 also includes an annular protrusion 116 (e.g., a second annular protrusion) extending perpendicularly from the disc 110 with respect to the vertical axis 92. The annular protrusion 116 has an inner edge 118 and an outer edge 120. The annular recess 102 of the first gear 70 is configured to receive at least a portion of the annular protrusion 116 of the second gear 72, thereby establishing an overlap between the first and second gears with respect to the vertical axis 92. As a result, the extent of the dual-output clutch assembly 66 along the vertical axis 92 may be reduced (e.g., as compared to a dual-output clutch assembly in which the first and second gears do not overlap one another with respect to the vertical axis of the dual-output clutch assembly). The second set of recesses 80 is formed at the inner edge 118 of the annular protrusion 116. In addition, a respective bearing 88 is radially disposed between the inner edge 114 (e.g., an inner circumference) of the disc 110 and the shaft 68.

In the illustrated embodiment, a bushing 86 is disposed between the first gear 70 and the second gear 72. The bushing 86 is at least partially disposed within the annular recess 102 of the first gear 70, and the bushing 86 is radially disposed between the inner edge 104 of the disc 98 of the first gear 70 and the outer edge 120 of the annular protrusion 116 of the second gear 72. The bushing 86 is configured to facilitate rotation of the first and second gears relative to one another (e.g., while one radial pin clutch is engaged and the other radial pin clutch is disengaged). The bushing 86 may be formed from any suitable material(s), such as polymeric material(s). While the gear drive assembly includes the bushing 86 in the illustrated embodiment, in other embodiments, the bushing may be omitted. For example, in certain embodiments, the gear drive assembly may include a bearing radially disposed between the first and second gears. While the first gear 70 has the annular recess 102 and the second gear 72 has the annular protrusion 116 configured to engage the annular recess 102 in the illustrated embodiment, in other embodiments, the second gear may have an annular recess and the first gear may have an annular protrusion configured to engage the annular recess. Furthermore, while the first and second gears overlap one another with respect to the vertical axis of the dual-output clutch assembly in the illustrated embodiment, in other embodiments, the first and second gears may not overlap one another.

Each of the radial pin clutches operates in two states: an engaged state and a disengaged state. With both radial pin clutches in the engaged state, both gears are non-rotatably coupled to the shaft 68, such that the gears rotate with the shaft 68. The rotation of the gears drives the rotor assemblies and the doffers to rotate, such that each rotor assembly and each doffer is driven to rotate while (e.g., only while) the respective radial pin clutch is engaged. As previously discussed, each radial pin clutch is engaged while the respective set of radial pins is fully disposed within the respective set of recesses such that the respective set of radial pins block the rotation of the respective gear about the shaft. Furthermore, as previously discussed, each set of recesses is configured to drive the respective set of pins to a respective disengaged state in response to a torque between the respective gear and the shaft exceeding a respective threshold torque. While the respective set of pins is in the respective disengaged state, the respective set of pins is disengaged from the respective set of recesses. For example, each of the respective set of pins move radially outward such that, even when aligned with a subsequent recess of the respective set of recesses, each of the respective set of pins do not engage the subsequent recesses due to the rotational speed differential between the shaft and the respective gear. Accordingly, the respective radial pin clutch is in the disengaged state. While the respective radial pin clutch is in the disengaged state, the shaft may rotate relative to the respective gear. Thus, the respective rotor assembly and the respective doffer may stop rotating while the respective radial pin clutch is disengaged. However, rotation of the shaft 68 may continue to drive the other gear to rotate, thereby driving the other rotor assembly and doffer to rotate. The first radial pin clutch 74 and the second radial pin clutch 76 may operate in different states concurrently. For example, while the first radial pin clutch is engaged and the second radial pin clutch is disengaged, the first gear may be driven to rotate, thereby driving the first rotor assembly and the first doffer to rotate, and rotation of the second gear, the second rotor assembly, and the second doffer may terminate.

Each rotor assembly may accumulate agricultural product and/or foreign materials within the rotor assembly, thereby increasing the resistance of the rotor assembly to rotate. The accumulation within the respective rotor assembly may increase the respective torque between the respective gear and the shaft, such that the torque exceeds the respective threshold torque. Consequently, the respective radial pin clutch may disengage, thereby enabling the respective gear and rotor assembly to stop rotating while the shaft continues to drive the other gear and rotor assembly to rotate. The accumulation may be cleared from the respective rotor assembly, thereby enabling the respective radial pin clutch to reengage, thereby restarting rotation of the respective rotor assembly.

In the illustrated embodiment, the first radial pin clutch 74 includes a first set of springs 122, and the second radial pin clutch 76 includes a second set of springs 124. Each spring is configured to urge a respective pin radially outwardly (e.g., outwardly with respect to the radial axis 96). Accordingly, each spring is configured to urge the respective pin into engagement with the respective recess while the pin is aligned with the respective recess. As previously discussed, while each set of pins is engaged with the corresponding set of recesses, the respective gear is non-rotatably coupled to the shaft 68. In response to a respective torque between the respective gear and the shaft exceeding the respective threshold torque, the respective set of recesses drives the respective set of pins to the respective disengaged state (e.g., against the bias provided by the respective set of springs), thereby enabling rotation of the respective gear about the shaft 68. Each threshold torque may be selected based on the spring constant of each spring of the respective set of springs, the shape of each recess of the respective set of recesses, and the shape of each pin of the respective set of pins. The first threshold torque of the first radial pin clutch may be the same as or different from the second threshold torque of the second radial pin clutch. While each radial pin clutch includes a set of springs in the illustrated embodiment, in other embodiments, at least one radial pin clutch may include a set of other suitable biasing devices (e.g., hydraulic cylinders, pneumatic cylinders, resilient members, etc.) configured to urge the set of pins radially outwardly.

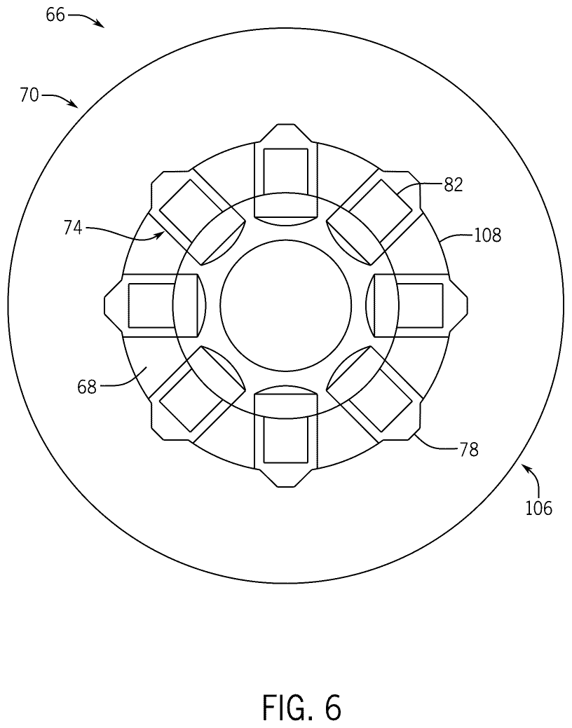

FIG. 6 is a top first cross-sectional view of the dual-output clutch assembly 66 of FIG. 4, taken along line 6-6 of FIG. 4. As previously discussed, the first set of recesses 78 is configured to receive the first set of pins 82. Although the dual-output clutch assembly includes eight recesses in the first set of recesses 78 and eight pins in the first set of pins 82 as illustrated, the first set of recesses 78 may include more or fewer recesses (e.g., 2, 3, 4, 5, 6, 7, 9, 10, or more), and the first set of pins 82 may include more or fewer pins (e.g., 2, 3, 4, 5, 6, 7, 9, 10, or more). In addition, the first set of recesses 78 is formed at the inner edge 108 of the annular protrusion 106 of the first gear 70. Furthermore, the first set of pins 82 is movably coupled to the shaft 68.

While the first radial pin clutch 74 is engaged, the first set of pins 82 is engaged with the first set of recesses 78 of the first gear 70. The first set of pins 82 is movably coupled to the shaft 68, and the first set of pins 82 is configured to move in a radial direction between the first engaged state and the first disengaged state. The first set of pins 82 is configured to engage the first set of recesses 78 while in the first engaged state to block rotation of the first gear 70 about the shaft 68. While the first radial pin clutch 74 is disengaged, the first set of pins 82 is disengaged from the first set of recesses 78. Thus, the first set of pins 82 is in the first disengaged state, thereby enabling the first gear to rotate about the shaft 68. Therefore, the shaft 68 may rotate without driving the first gear 70 to rotate.

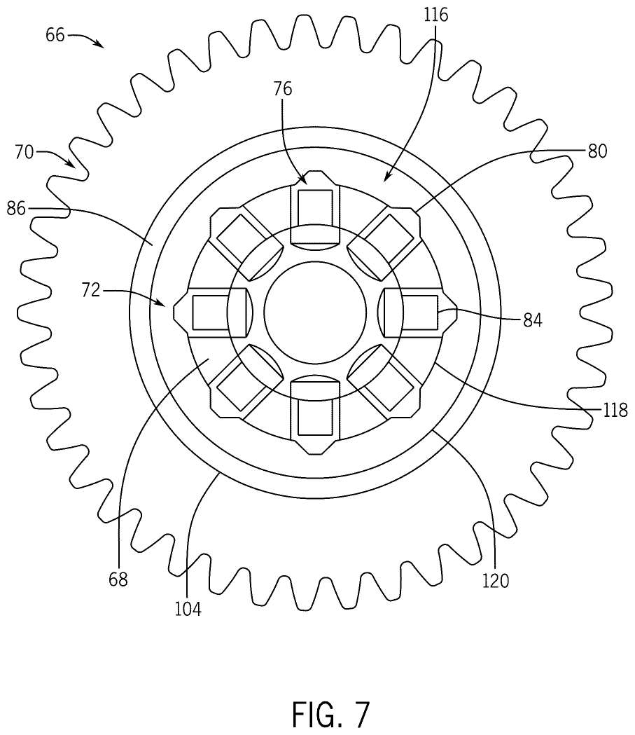

FIG. 7 is a top view of a second cross-section of the dual-output clutch assembly of FIG. 4, taken along line 7-7 of FIG. 4. As previously discussed, the second set of recesses 80 is configured to receive the second set of pins 84. Although the dual-output clutch assembly includes eight recesses in the second set of recesses 80 and eight pins in the second set of pins 84 as illustrated, the second set of recesses 80 may include more or fewer recesses (e.g., 2, 3, 4, 5, 6, 7, 9, 10, or more), and the second set of pins 84 may include more or fewer pins (e.g., 2, 3, 4, 5, 6, 7, 9, 10, or more). In addition, the second set of recesses 80 is formed at the inner edge 118 of the annular protrusion 116 of the second gear 72. Furthermore, the second set of pins 84 is movably coupled to the shaft 68. The bushing 86 is disposed between the outer edge 120 of the annular protrusion 116 of the second gear 72 and the inner edge 104 of the disc 98 of the first gear 70, such that the bushing is disposed between the first gear 70 and the second gear 72.

While the second radial pin clutch 76 is engaged, the second set of pins 84 is engaged with the second set of recesses 80 of the second gear 72. The second set of pins 84 is movably coupled to the shaft 68, and the second set of pins 84 is configured to move in a radial direction between the second engaged state and the second disengaged state. The second set of pins 84 is configured to engage the second set of recesses 80 while in the second engaged state to block rotation of the second gear 72 about the shaft 68. While the second radial pin clutch 76 is disengaged, the second set of pins 84 is disengaged from the second set of recesses 80. Thus, the second set of pins 84 is in the second disengaged state, thereby enabling the second gear to rotate about the shaft 68. Therefore, the shaft 68 may rotate without driving the second gear 72 to rotate.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A gear drive assembly, comprising:
a dual-output clutch assembly comprising:
a shaft;
a first gear configured to drive a first rotor assembly and a first doffer to rotate;
a second gear configured to drive a second rotor assembly and a second doffer to rotate;
a first radial pin clutch comprising a first plurality of radial pins movably coupled to the shaft, wherein the first gear has a first plurality of recesses configured to receive the first plurality of radial pins, the first plurality of radial pins is configured to move in a radial direction between a first engaged state and a first disengaged state, the first plurality of radial pins is configured to engage the first plurality of recesses while in the first engaged state to block rotation of the first gear about the shaft, and the first plurality of recesses is configured to drive the first plurality of radial pins to the first disengaged state to enable rotation of the first gear about the shaft in response to a first torque between the first gear and the shaft exceeding a first threshold torque; and
a second radial pin clutch comprising a second plurality of radial pins movably coupled to the shaft, wherein the second gear has a second plurality of recesses configured to receive the second plurality of radial pins, the second plurality of radial pins is configured to move in the radial direction between a second engaged state and a second disengaged state, the second plurality of radial pins is configured to engage the second plurality of recesses while in the second engaged state to block rotation of the second gear about the shaft, the second plurality of recesses is configured to drive the second plurality of radial pins to the second disengaged state to enable rotation of the second gear about the shaft in response to a second torque between the second gear and the shaft exceeding a second threshold torque, and the first radial pin clutch is configured to operate independently of the second radial pin clutch.

2. The gear drive assembly of claim 1, wherein the first gear is configured to drive the first rotor assembly to rotate only while the first plurality of radial pins is engaged with the first plurality of recesses, and the second gear is configured to drive the second rotor assembly to rotate only while the second plurality of radial pins is engaged with the second plurality of recesses.

3. The gear drive assembly of claim 1, wherein the second gear has a disc and an annular protrusion extending perpendicularly from the disc, and the first gear has an annular recess configured to receive at least a portion of the annular protrusion.

4. The gear drive assembly of claim 3, comprising a bushing at least partially disposed within the annular recess of the first gear, wherein the bushing is radially disposed between the annular protrusion of the second gear and the first gear to facilitate rotation of the first and second gears relative to one another.

5. The gear drive assembly of claim 1, comprising a bearing radially disposed between the shaft and the first gear.

6. The gear drive assembly of claim 1, comprising a bearing radially disposed between the shaft and the second gear.

7. The gear drive assembly of claim 1, wherein the first radial pin clutch comprises a first plurality of springs configured to urge the first plurality of radial pins outwardly in a radial direction.

8. The gear drive assembly of claim 1, wherein the second radial pin clutch comprises a second plurality of springs configured to urge the second plurality of radial pins outwardly in a radial direction.

9. A row unit, comprising:
a first rotor assembly;
a second rotor assembly; and
a dual-output clutch assembly comprising:
a shaft;
a first gear configured to drive the first rotor assembly to rotate;
a second gear configured to drive the second rotor assembly to rotate;
a first radial pin clutch comprising a first plurality of radial pins movably coupled to the shaft, wherein the first gear has a first plurality of recesses configured to receive the first plurality of radial pins, the first plurality of radial pins is configured to move in a radial direction between a first engaged state and a first disengaged state, the first plurality of radial pins is configured to engage the first plurality of recesses while in the first engaged state to block rotation of the first gear about the shaft, and the first plurality of recesses is configured to drive the first plurality of radial pins to the first disengaged state to enable rotation of the first gear about the shaft in response to a first torque between the first gear and the shaft exceeding a first threshold torque; and
a second radial pin clutch comprising a second plurality of radial pins movably coupled to the shaft, wherein the second gear has a second plurality of recesses configured to receive the second plurality of radial pins, the second plurality of radial pins is configured to move in the radial direction between a second engaged state and a second disengaged state, the second plurality of radial pins is configured to engage the second plurality of recesses while in the second engaged state to block rotation of the second gear about the shaft, the second plurality of recesses is configured to drive the second plurality of radial pins to the second disengaged state to enable rotation of the second gear about the shaft in response to a second torque between the second gear and the shaft exceeding a second threshold torque, and the first radial pin clutch is configured to operate independently of the second radial pin clutch.

10. The row unit of claim 9, wherein the second gear has a disc and an annular protrusion extending perpendicularly from the disc, and the first gear has an annular recess configured to receive at least a portion of the annular protrusion.

11. The row unit of claim 10, comprising a bushing at least partially disposed within the annular recess of the first gear, wherein the bushing is radially disposed between the annular protrusion of the second gear and the first gear to facilitate rotation of the first and second gears relative to one another.

12. The row unit of claim 9, wherein the first gear has a first annular protrusion, the second gear has a second annular protrusion, the first plurality of recesses is formed within the first annular protrusion, and the second plurality of recesses is formed within the second annular protrusion.

13. The row unit of claim 9, wherein the dual-output clutch assembly comprises a plurality of bearings disposed along an outer circumference of the shaft.

14. The row unit of claim 13, wherein a first bearing of the plurality of bearings is radially disposed between the outer circumference of the shaft and an inner circumference of the first gear, and a second bearing of the plurality of bearings is radially disposed between the outer circumference of the shaft and an inner circumference of the second gear.

15. The row unit of claim 9, wherein the first gear overlaps the second gear along an axial direction.

16. The row unit of claim 9, wherein the first radial pin clutch comprises a first plurality of springs configured to urge the first plurality of radial pins outwardly in a radial direction, and the second radial pin clutch comprises a second plurality of springs configured to urge the second plurality of radial pins outwardly in the radial direction.

17. The row unit of claim 9, wherein an outer edge of the first gear comprises first gear teeth, and an outer edge of the second gear comprises second gear teeth.

18. The row unit of claim 9, comprising:
a first doffer, wherein the first gear is configured to drive the first rotor assembly and the first doffer to rotate; and
a second doffer, wherein the second gear is configured to drive the second rotor assembly and the second doffer to rotate.

19. A method of manufacturing a dual-output clutch assembly for a gear drive assembly, comprising:
disposing a first radial pin clutch and a first gear about a shaft, such that the first radial pin clutch is disposed between the shaft and the first gear, wherein the first gear is configured to drive a first rotor assembly to rotate; and
disposing a second radial pin clutch and a second gear about the shaft, such that the second radial pin clutch is disposed between the shaft and the second gear, wherein the second gear is configured to drive a second rotor assembly to rotate;
wherein the first radial pin clutch comprises a first plurality of radial pins movably coupled to the shaft, the first gear has a first plurality of recesses configured to receive the first plurality of radial pins, the first plurality of radial pins is configured to move in a radial direction between a first engaged state and a first disengaged state, the first plurality of radial pins is configured to engage the first plurality of recesses while in the first engaged state to block rotation of the first gear about the shaft, and the first plurality of recesses is configured to drive the first plurality of radial pins to the first disengaged state to enable rotation of the first gear about the shaft in response to a first torque between the first gear and the shaft exceeding a first threshold torque;
wherein the second radial pin clutch comprises a second plurality of radial pins movably coupled to the shaft, the second gear has a second plurality of recesses configured to receive the second plurality of radial pins, the second plurality of radial pins is configured to move in the radial direction between a second engaged state and a second disengaged state, the second plurality of radial pins is configured to engage the second plurality of recesses while in the second engaged state to block rotation of the second gear about the shaft, and the second plurality of recesses is configured to drive the second plurality of radial pins to the second disengaged state to enable rotation of the second gear about the shaft in response to a second torque between the second gear and the shaft exceeding a second threshold torque; and
wherein the first radial pin clutch is configured to operate independently of the second radial pin clutch.

20. The method of claim 19, comprising:
disposing a first bearing of a plurality of bearings between an outer circumference of the shaft and an inner circumference of the first gear; and
disposing a second bearing of the plurality of bearings between the outer circumference of the shaft and an inner circumference of the second gear.
